(19) United States
(12) Patent Application Publication
(10) Pub. No.: US 2017/0245549 A1
(43) Pub. Date: Aug. 31, 2017

(54) Electronic hookah

(71) Applicant: Madvapes llc, Oceanside, CA (US)

(72) Inventor: Brandon nedelman Nedelman, Oceanside, CA (US)

(73) Assignee: brandon nedelman, Oceanside, CA (US)

(21) Appl. No.: 15/055,591

(22) Filed: Feb. 27, 2016

(51) Int. Cl. A24F 47/00; G06F 3/0484; G06F 3/0488; A24F 1/30; G06F 3/041

(52) U.S. Cl. CPC A24F 47/008; A24F 1/30; G06F 3/0416; G06F 3/04883; G06F 3/0484

(57) ABSTRACT

An electronic hookah machine featuring high compression and smoke quantity from the processing of electronic cigarette liquid. Juice in the first processing chamber is vaporized and transferred via fan and motor from first chamber, and vacuum from second chamber, into the second chamber. The second chamber contains an electric motor driven compression piston which compresses the drawn smoke able vapor, before user opens the release valve and smoke able vapor is released into hose and nozzle for user to smoke.

### BACKGROUND ART

Hookah, is smoking style with its origins rooted in ancient Middle Eastern culture. A hookah machine is loaded with sweet flavored tobacco, which is filtered through water, resulting in the production of large quantity of smooth smoke. The tobacco is first loaded into a chamber, and then the chamber is sealed at the top with a metal cover. The top of the chamber is heated by burning coals, as the tobacco is slowly burned and passed through a water filter. The final filtered smoke product is inhaled through a small hose and nozzle as the flavored and filtered smoke is enjoyed. The hookah experience has become very prominent and popular social experience in generation x. Teenagers and young adults often incorporate hookah into small social events. “Hookah bars “are indoor lounges dedicated specifically to hookah, and. groups of customers will pay to temporarily rent and use the machines.

The electronic cigarette, or vape market is relatively new and closely related to the same subcultural makeup. An electronic cigarette is a pen style device that is filled with electronic cigarette liquid. The e-liquid is converted into a smoke-able vapor by an atomizer component, via step up transformation, or a coil, prior to being vaped. The result is a smooth, water based vapor product which is inhaled through an opening at the top of the upright pen.

### SUMMARY

The invention is a hookah/shisha shaped/simulation designed electronic atomization cigarette machine wherein the atomized vapor created of the machines atomizer is compressed prior to its dispense from the machine for user inhalation comprising:

Housing/shell: 101 is the machine housing or shell that is shaped like a “vase” to produce and resemble, or simulate a hookah/shisha experience. The housing contains all internal assembled components as well as provides a hookah-like appearance in design structure;

Tank: 114 is the e-juice or refillable e-liquid “propylene glycol flavored juice mixture” reservoir or tank. The reservoir/tank stores filled liquid in the machine for its function. The reservoir/tank is refillable through a junction 115 that extends from 114 the reservoir/tank to/through the outer wall of 101 the housing. Refill e-juice can be poured into the machines reservoir tank via junction 115.

The machine possesses a means of transferring reservoir liquid to the atomizer, and in most e-cigarettes this function is inherently performed by a wick.

Atomizer: 110 is an electronic cigarette type “atomizer” or “vaporizer. It receives computer 107 controlled source battery 102 electricity at its electronic connection portions for circuit wires, 109, to perform the function of atomizing liquid e-juice thus converting it into smoke-able/inhalation vapor for the end user upon dispense from the machine.

Vapor transfer: 117 is a junction from the 110 atomizer to the machines compression chamber 118. It contains a motor 121 driven fan 122 assembly which forcefully inducts generated/produced inhalation vapor of the 110 atomizer upon distribution of computer 107 controlled source battery 102 power supply signal to the motor 121. the machine may further contain additionally means of facilitating the transfer of atomized vapor into compression chamber 118, such as routed installed vacuum lines utilizing functions inherent inside of compression chamber 118.

Compression mechanism: 112 is the driving electric motor for the machines compression mechanism. Upon receipt of computer 107 regulated source battery 102 supply electricity, 112 the electric motor responds the compression mechanism operation further comprising:

119 a compression piston, junctioned to its respective;

113 piston connecting rod, junctioning 119 the compression piston to its respective lobe on;

111 the piston crankshaft which is junctioned to 112 the compression/piston mechanism motor so that when the 112 motor is delivered electricity as such, it spins the 111 crankshafts thus responding upward and downward cycling motion of the 113 connecting rod. The motion of the 113 connecting rod directly drives the end junctioned compression piston 119 which resides in compression chamber 119. Thus, when the motor 112 is so engaged, the ultimate motion cycling of 119 the piston inside of chamber 118 creates the function of compression. As indicated, the motor/fan assembly 121/122 drives the inflow of produced vapor at 110 the atomizer into the chamber 118 wherein it is compressed prior to or consistent with its dispense from the cigarette machine for end user inhalation.

Electromagnetic Piston Assist: Inside the chamber 118 is an aimed electromagnetic rod 123 in which a step-up transformer 124 transmits power from source computer 107 control/regulation/battery 102 so that, synchronous with the operation of the electric motor 112 which drives the piston 119, on only its upward or compression motion. This on and off switching, of the transformer signal flow, is controlled by an electronic distribution timing system comprised of the following: A crankshaft position sensor (located in an applicable area relative to the crankshaft 111 internal the housing 101) which locates the crankshafts 111 position and distributes the signal to: 107 computer unit, which consisting of the very at least memory and processing functions and parts, which receives the signal and distributes on and off power to the transformer accordingly, to power the on and off switching of power supply to the electromagnetic rod 123. It receives a step up/transformed pulse signal from the computer 107 on the upward motion of the two-stroke piston 119 cycle, which is inputted by a crankshaft position sensor 125, so that on the upward motion of the piston 119, the transformer 124 pulse engages the electromagnet pulling the piston 119.

Vapor Dispense/Release: 120 dispense valve is an electronically controlled vapor flow valve respond able by user/operator engagement of 103 touchscreen panel which is fastened/assembled to be accessible at its mounting point manifesting accessibility of the touchscreen control interface on the outer housing 101 of the machine. 103 the touchscreen is used to manage touch-gesture responses of the 107-computer signal governance of electricity from source 102 via its input to the cpu pursuant to user touch engagement. The said computer response signaling scenarios regard piston compression operation and outflow controlling of dispensed compressed vapor from 120 the dispense valve. The touchscreen functions allow engagement/disengagement management of computer distribution to the mechanisms functioning piston/motor compression, as well as control of the release function of the 120 valve.

104 the flexible hookah style discharge hose is designed to simulate traditional hookah/shisha. It is junctioned to the release or outlet side of the valve 120 to receive outputted compressed atomized vapor and through the length of its structure, ultimately transfer outputted compressed dispensed vapor from 120 valve to the final downstream location which is the likewise hookah-style 105 inhalation nipple/mouthpiece, which the user places his or her mouth upon and wherein the vapor is outed from this point of the machine for direct inhalation.

### Technical Problem and Solution

The problem that exists today is that there is a market need, currently, that takes advantage of the social aspects of smoking in the context of electronic cigarettes, and the younger generation, and although many vape in social settings, the designs of contemporary vapes are certainly geared toward solitary use. The goal is to address this market need by applying to the younger generation. Hookah is the most social of all smoking events, however, no other form of smoking is as socially involved. Electronic cigarettes, while often found at social events, have a base of consumers who do vape socially, with the lack of a new product (for that consumer market) that fully taps into the social aspects of the smoking market and sub culture. By creating a machine that utilizes mechanical compression of electronic cigarette vapor, not only could a market application be crated because the design resembles hookah, but an even bigger marketing solution was created by the fact that the effect of compressing the vapor is highly marketable, especially to a younger generation who would find it appealing. The problem is solved because a solution is created for the need to tap into the social aspects of smoking, as it applies to the electronic cigarette industry. The invention has manifested itself as an electronic cigarette machine. The invention solves a marketing need by creating a highly marketable application of the new e cigarettes market, and the hookah market, combining them so that an enjoyable article of manufacture is created. It is marketable towards the social smoking sub-crowd, as seen with contemporary hookah, and often overlooked in more solitary vape-pen designs. It is less harmful than burned tobacco, and the compression effects and elements are new. The marketability of the invention is complimented further by the hookah style design, and modern application of the digitizer touchscreen. As stated, the marketing solution of the invention is further enhanced by the touchscreen panel which has high-tech market appeal.

### Advantages

The solution is a unit not only capable of providing enough smoke for a social hookah experience, but has the potential to produce large quantities of smoke production never achieved before in the electronic cigarette world.

### DRAWINGS

FIG. 1 is a front view of the outside of the atomization/compression hookah machine.

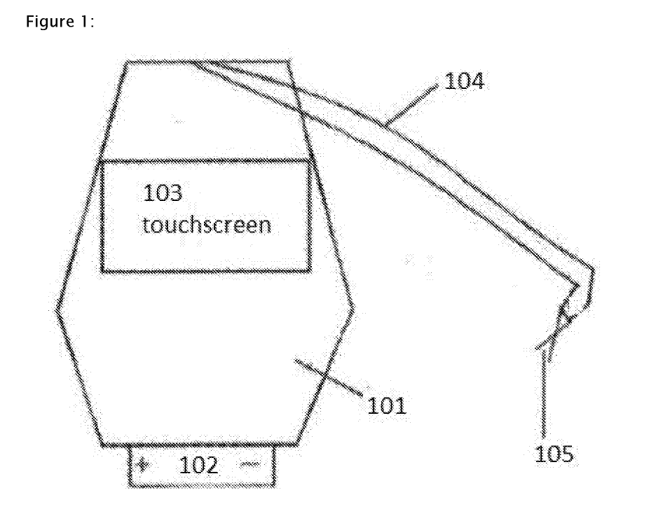

FIG. 2 is an internal mechanical parts/components diagram.

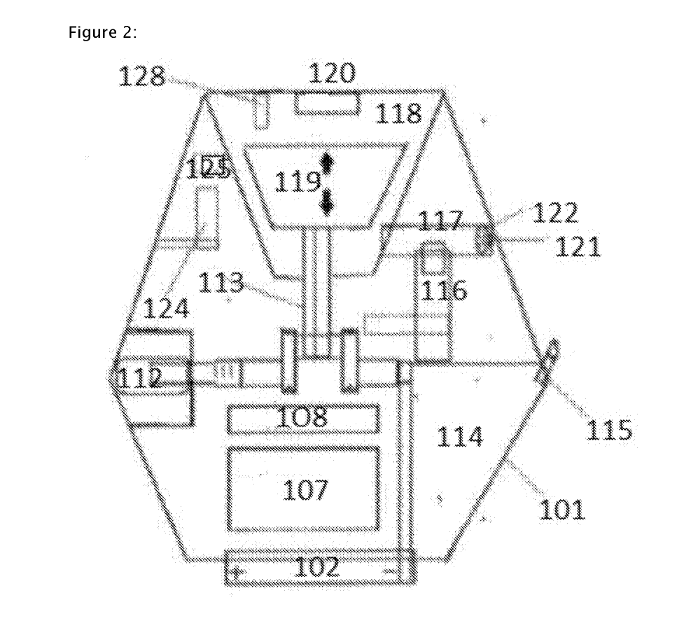

### EMBODIMENT FIGURES

101 housing/shell;

102 battery;

103 touchscreen operation panel interface;

104 hookah-style flexible hose;

105 hookah-style inhalation mouthpiece;

107 computer chip or circuit;

108 atomizer circuit path coil;

109 atomizer path electric connection terminals;

110 atomizer;

111 compression crankshaft;

112 compression electric motor;

113 piston connecting rod;

114 refillable liquid chamber/reservoir/tank;

115 fill junction for reservoir/tank;

117 atomizer/compression chamber junction;

118 compression piston chamber;

119 compression piston;

120 dispense valve;

121 fan motor;

122 fan;

123 electromagnetic piston assist rod;

124 electromagnetic rod coil;

125 crankshaft position sensor.

### Claims Glossary

Substance of matter: a compound or element of physical state of matter, being solid liquid or gas.

e-juice or e-liquid: refillable liquid for electronic atomizer cigarettes that are used by the machine to convert the said liquid into vapor or “aerosol” for end user inhalation.

Touchscreen; touchscreen panel; touchscreen interface: an interface or panel or control unit containing a display screen that performs a secondary function of an input command interface to its respective computer, the like of a modern “smartphone mobile device” possessing what is referred to as a touchscreen.

Responsive component: electrical and/or mechanical user engageable part of a machine that when engaged by the user, causes the machine to perform a specific function or process as a response.

Hose/mouthpiece assembly: an assembly comprising a hose and a mouthpiece as described in the specification, like that of a hookah or shisha machine.

Crankshaft: a mechanical shaft that drives or is driven by a piston and/or its related junctioned associated parts.

Connecting rod or piston-connecting rod: a component that connects or junctions a piston to a crankshaft.

Compression chamber or piston compression chamber: enclosed chamber housing one or more pistons which motion inside of the said chamber. In this invention, piston motion inside f the chamber creates compression.

1. An electronic cigarette machine for vaping wherein the generated or produced vapor of the machine is compressed prior to or consistent with its dispense from the machine for end user inhalation.

2. The machine of claim 1 wherein the vapor is produced by an atomizer which converts a substance of matter that is stored inside of the machine into said vapor.

3. The machine of claim 1 comprising:
A housing or shell;
An atomizer, and its associated circuitry;
A power supply or source for electrical circuits of the machine;
A storage of a substance of matter inside the machine;
Wherein the atomizer converts the stored substance of matter into vapor; and
A mechanism of compressing the generated or produced vapor of the atomizer, prior to, or consistent with, its dispense from the machine for end user inhalation.

4. The machine of claim 3 wherein the atomizer circuit contains a coil wherein the coil modifies voltage through the circuit.

5. The machine of claim 3 wherein the stored substance of matter is e-juice or e-liquid.

6. The machine of claim 3 wherein the mechanism of compression utilizes the motion one or more compression pistons.

7. The machine of claim 3 further comprising a responsive component which responds the dispense or release of compressed vapor from the machine pursuant to its engagement by an operator or end user of the machine.

8. The machine of claim 3 further comprising a responsive component which responds the engagement or disengagement of the compression mechanism of the machine pursuant to its engagement by an operator or end user of the machine.

9. The machine of claim 3 further comprising a touchscreen panel or interface.

10. The machine of claim 3 wherein the electricity/power supply is a battery assembled as a component of the machine.

11. The machine of claim 3 further comprising a hose and mouthpiece assembly wherein discharged, compressed vapor is outputted from the machine for user inhalation through the hose/mouthpiece assembly.

12. The machine of claim 3 further comprising a valve wherein the output vapor of the machine is passed through the valve pursuant to its dispense from the machine for inhalation.

13. The machine of claim 3 further comprising a computer processing circuit which regulates or governs the electricity distribution to the circuitry of the machine.

14. The machine of claim 5 further comprising a reservoir or tank for the storage of the e-juice or e-liquid wherein the reservoir or tank is refillable.

15. The machine of claim 6 wherein the compression mechanism of components comprises:
An electric motor;
A crankshaft junctioned to the motor wherein the motors operation induces motion of the crankshaft;
At least one piston-connecting-rod(s) junctioned to the crankshaft;
At least one compression piston(s) junctioned to the piston-connecting rod(s); and
At least one compression chamber(s) housing the piston(s);
Wherein the motor induced motion of the crankshaft responds motion of the piston(s) and connecting-rod(s) to create compression inside of the chamber(s) via the motion of the said piston(s).

16. The machine of claim 12 further comprising a responsive component that responds the dispense or release of vapor, outputted through the valve.

17. The machine of claim 12 further comprising a hose and mouthpiece assembly junctioned to the output portion of the valve:
Wherein discharged compressed vapor is outputted from the machine for user inhalation through the hose/mouthpiece assembly subsequently after it has passed through the junctioned valve.

18. The machine of claim 13 further comprising a responsive component that manipulates the computer processing functions pursuant to user engagement.

19. The machine of claim 15 further comprising a means of facilitating or inducing the transfer of produced vapor from the atomizer to the compression chamber.

20. The machine of claim 16 wherein the responsive component is a touchscreen panel or interface.
